(19) United States
(12) Patent Application Publication
(10) Pub. No.: US 2005/0074079 A1
(43) Pub. Date: Apr. 7, 2005

(54) RFI canceller

(76) Inventor: Gary Qu Jin, Kanata (CA)

Correspondence Address: MARKS & CLERK, P.O. BOX 957, STATION B, OTTAWA, ON, K1P 5S7, CA

(21) Appl. No.: 10/352,983

(22) Filed: Jan. 29, 2003

(30) Foreign Application Priority Data
Jan. 31, 2002 (GB) 0202191.3

(51) Int. Cl. H04L 1/00

(52) U.S. Cl. 375/346; 455/296

(57) ABSTRACT

Narrow band RF interference in a modulated signal carried on a plurality of subchannels is carried out by detecting RF interference in the subchannels, identifying a subchannel where the magnitude of the RF interference has a predetermined characteristic, determining the value of the magnitude of the RF interference with the predetermined characteristic, determining the value of the magnitude of the RF interference in neighboring subchannels, estimating the value of the magnitude of the RF interference the remaining subchannels from the determined values, and subtracting the estimated values of the magnitude of the RF interference from the signals in the corresponding remaining subchannels.

### FIELD OF THE INVENTION

This invention relates to the field of communications, and in particular to an RFI canceller suitable for use, for example, in a discrete multitone (DMT) digital subscriber line (DSL) system.

### BACKGROUND OF THE INVENTION

DMT is a modulation scheme used in DSL systems, wherein a wideband modulated signal is carried on a number of discrete carriers or tones. Each tone constitutes a subchannel that is independently modulated to carry part of the bits in the information.

In a DMT based DSL system, radio frequency interference (RFI) is an important interference source and its cancellation is a difficult task. The DMT signal is a wide band modulated signal with each subchannel being modulated independently to carry part of information bits. In the receiver, FFT (Fast Fourier Transform) is normally used to separate subchannels which are orthogonal with each other in frequency domain. See, “Very-high-bit-rate Digital Subscriber Line (VDSL) Metallic Interface Part 1: Functional Requirements and Common Specification”, T1E1.4/2001-009R2, Ottawa, Canada Aug. 20-24, 2001. On the other hand, RFI is normally a narrow band interference which seems not affect DMT signal too much. However, due to the FFT window effect, the narrow band RF signal may not be orthogonal to DMT signals and will cause interference to its neighboring subchannels. Indeed, since RFI could be 30 dB above the DMT signal, its sidelobe may jam many DMT subchannels. Proper windowing, VDSL: fiber-fast data transmission over copper pairs”, Alcatel Telecommunications Review, 2000, pp. 277-287 can effectively reduce the sidelobe of RFI and hence reduce the level of interference to many DMT subchannels. However, RF interference may still cause significant performance degradation to its neighboring 10-20 subchannels due to its high interference strength.

### SUMMARY OF THE INVENTION

In this invention, the novel RFI cancellation technique can potentially reduce the RF interference by an extra 30 dB. The method is based on the fact that the RFI is a narrow band signal and its strength and location will provide enough information to predict its interference to other DMT subchannels, and hence can be subtracted from received signal in these subchannels.

According to the present invention there is provided a method of canceling RF interference in a modulated signal carried on a plurality of subchannels, comprising detecting RF interference in said subchannels; identifying a said subchannel where the magnitude of said RF interference has a predetermined characteristic; determining the value of said magnitude of said RF interference with said predetermined characteristic; determining the value of the magnitude of said RF interference in neighboring subchannels; estimating the value of the magnitude of said RF interference in a plurality of remaining subchannels from said determined values; and subtracting the estimated values of the magnitude of said RF interference from the signals in the corresponding remaining subchannels.

Normally the predetermined characteristic magnitude is the peak magnitude of the RF interference, although in theory the subchannel chosen could be the subchannel where the magnitude is the second greatest, for example. Normally the neighboring subchannels are located on either side of said channel where the RF interference has a peak magnitude, preferably immediately adjacent those channels.

The invention also provides an RF interference canceller for canceling RF interference in a modulated signal carried on a plurality of subchannels, comprising a detector for detecting RF interference in said subchannels, identifying a said subchannel where the magnitude of said RF interference has a predetermined characteristic, determining the value of said magnitude of said RF interference with said predetermined characteristic, and determining the value of the magnitude of said RF interference in neighboring subchannels; an estimator for estimating the value of the magnitude of said RF interference in a plurality of remaining subchannels from said determined values; and a subtractor for subtracting the estimated values of the magnitude of said RF interference from the signals in the corresponding remaining subchannels.

The invention is intended primarily for use DMT DSL systems, although it could find application in other technologies where a similar problem arises.

### BRIEF DESCRIPTION OF THE DRAWINGS

The invention will now be described in more detail, by way of example only, with reference to the accompanying drawings, in which the single FIGURE is a block diagram of a structure for implementing an RFI canceller in accordance with the invention.

### DETAILED DESCRIPTION OF THE PREFERRED EMBODIMENTS

In order to fully understand the invention it will be helpful to understand the theory on which it is based. Let's assume that RFI is a narrow band signal with frequency located at location related with FFT as

$${ω}_{0} = 2 π \frac{( {k}_{1} + Δ )}{N} ,$$

−0.5≦Δ≦0.5 and k₁ is an integer and its time domain waveform looks like
Ae^{j(ω}^{₀}^{n+θ)}

The Fourier transform of such narrow band signal can be expressed as

$$\begin{matrix}R ( k ) \approx A {ⅇ}^{j θ} {\sum }_{n} {ⅇ}^{j 2 π \frac{( {k}_{1} + Δ )}{N}} \cdot {ⅇ}^{- j 2 π n \frac{k}{N}} \\ = {ⅇ}^{j π [ Δ ( 1 - \frac{1}{N} ) + \frac{k - {k}_{1}}{N} ]} \frac{sin π Δ}{sin π ( \frac{Δ}{N} - \frac{k - {k}_{1}}{N} )} A {ⅇ}^{j θ}\end{matrix}$$

where the assumption that the window is close to rectangular even with a small edge roll off is applied. See, T1E1.4/2001-009R2 referred to above.

At k=k₁, we have

$$R ( {k}_{1} ) = {ⅇ}^{j π [ Δ ( 1 - 1 / N ) ]} \cdot \frac{sin π Δ}{sin ( π Δ / N )} \cdot A {ⅇ}^{j θ}$$

which is the peak location in the entire frequency subchannels if RFI present.

$$\begin{matrix}At & \\ k \neq {k}_{1} & \\ but & \\ k \approx {k}_{1} , & \\ we have & \\ \begin{matrix}R ( k ) = R ( {k}_{1} ) {ⅇ}^{j π \frac{k - {k}_{1}}{N}} \frac{sin π ( Δ / N )}{sin π ( Δ / N - ( k - {k}_{1} ) / N )} \\ \approx R ( {k}_{1} ) \frac{Δ}{Δ - ( k - {k}_{1} )}\end{matrix} & ( 1 )\end{matrix}$$

where we assume N is large comparing with (k−k₁).

Now Δ can be calculated with following relations:

$$\begin{matrix}{if}^{\vert R ( {k}_{1} + 1 ) \vert \geq \vert R ( {k}_{1} - 1 ) \vert} , we have & \\ Δ = \frac{\vert R ( {k}_{1} + 1 ) \vert}{\vert R ( {k}_{1} ) \vert + \vert R ( {k}_{1} + 1 ) \vert} & ( 2 ) \\ {if}^{\vert R ( {k}_{1} + 1 ) \vert < \vert R ( {k}_{1} - 1 ) \vert} , we have & \\ Δ = \frac{- \vert R ( {k}_{1} - 1 ) \vert}{\vert R ( {k}_{1} ) \vert + \vert R ( {k}_{1} - 1 ) \vert} & ( 3 )\end{matrix}$$

Summarizing Eq. (2) and (3), we have

$$\vert Δ \vert = \frac{max ( \vert R ( {k}_{1} + 1 ) \vert , \vert R ( {k}_{1} - 1 ) \vert )}{\vert R ( {k}_{1} ) \vert + max ( \vert R ( {k}_{1} + 1 ) \vert , \vert R ( {k}_{1} - 1 ) \vert )} \qquad ( 4 )$$

After calculating Δ, we can obtain all R(k) using Eq. (1) and subtract them from signals in the corresponding subchannels.

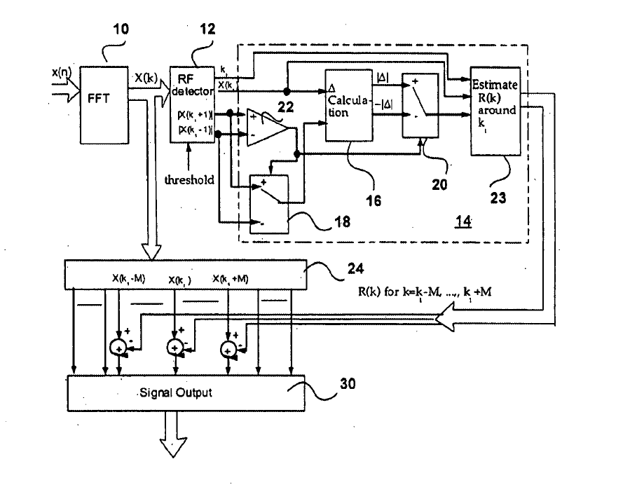

Referring now to FIG. 1, the structure shown may, for example, be implemented in a digital signal processor or conveniently integrated on to a single chip. In the structure shown in FIG. 1, a received modulated signal x(n) is input to an FFT unit 10, which outputs its fast Fourier transform X(k). This signal is X(k) is passed to RF detector 12 that outputs a signal k₁, which identifies the subchannel where the detected RF is a maximum, and a signal X(k₁), which is the value of the signal in the subchannel k₁. RF detector 12 also outputs signals |X(k₁+1)|, |(k₁−1)|. These signals are passed to an estimator 14, which estimates the value of the magnitude of RF interference in neighboring subchannels to the subchannel k₁.

The estimator 14 comprises Muxes 18, 20, Δ calculation block 16, an operational amplifier 22, and a final estimation block 23, which estimates the value of the interference R(k).

The signals X(k) are passed through block 24. The RF estimated RF interference signals are then subtracted from the M neighboring channels on either side of the subchannel k₁ where the RF interference is a maximum.

The processed output signal with the RF interference at least partially removed is output through signal output block 30. The blocks can be implemented using standard digital signal processing technology known to persons skilled in the art.

In the most applications using DMT technology, such as in a DSL system, no signal should be transmitted in the RF band to avoid interference. Therefore, strong RF interference can be detected by monitoring the signal level in the RF band and comparing with a proper threshold. This is done by RF detector block 12. As soon as radio frequency interference is detected, the peak signal X(k₁) and its location k₁ are outputted. The magnitude at its immediate neighbouring subchannels (|X(k₁+1)|, and |X(k₁−1)|) are also outputted. With strong RFI, the immediate neighbouring channels will also be dominated by RF signal. Therefore, in the Δ calculation block 16, |Δ| can be calculated using Eq. (4) with input X(k₁) and maxi {|X(k₁+1)|, |X(k₁−1)|}. The sign of Δ is determined by a comparator which takes |X(k₁+1)| and |X(k₁−1)| as the inputs. Using X(k₁) and value Δ, RFI at neighbouring 2M subchannels (location k₁−M, . . . , k₁+M) are estimated using Eq. (1) in the estimate block and then subtracted from the signal to get RFI free output.

It will be appreciated by one skilled in the art that many further variants are possible without departing from the scope of the appended claims.

1. A method of canceling narrow band RF interference in a modulated signal carried on a plurality of subchannels, comprising:
detecting RF interference in said subchannels;
identifying a said subchannel where the magnitude of said RF interference has a predetermined characteristic;
determining the value of said magnitude of said RF interference with said predetermined characteristic;
determining the value of the magnitude of said RF interference in neighboring subchannels;
estimating the value of the magnitude of said REF interference in a plurality of remaining subchannels from said determined values; and
subtracting the estimated values of the magnitude of said RF interference from the signals in the corresponding remaining subchannels.

2. A method as claimed in claim 1, wherein said predetermined characteristic is a peak magnitude.

3. A method as claimed in claim 2, wherein said neighboring subchannels are located on either side of said channel where the RF interference has a peak magnitude.

4. A method as claimed in claim 3, wherein said neighboring subchannels are immediately adjacent said channel where the RF interference has a peak magnitude.

5. A method as claimed in claim 1, wherein a Fourier transform is performed on said modulated signal prior to determining said magnitude of RF interference.

6. A method as claimed in claim 6, wherein said Fourier transform is a fast Fourier transform (FFT).

7. A method as claimed in claimed in claim 5, wherein the magnitude of the RF interference in said neighboring subchannels is estimated in accordance with the equation:
$$R ( {k}_{1} ) \frac{Δ}{Δ - ( k - {k}_{1} )}$$
where R(k) represents the interference in the channel k and Δ is calculated in accordance with the equation
$$\vert Δ \vert = \frac{max ( \vert R ( {k}_{1} + 1 ) \vert , \vert R ( {k}_{1} - 1 ) \vert )}{\vert R ( {k}_{1} ) \vert + max ( \vert R ( {k}_{1} + 1 ) \vert , \vert R ( {k}_{1} - 1 ) \vert )} \qquad ( 4 )$$

8. A method as claimed in claim 1, wherein said modulated signal is a DMT signal.

9. A method as claimed in claim 1, wherein said RF interference is determined by comparing a detected RF level with a predetermined threshold value.

10. An RF interference canceller for canceling narrow band RF interference in a modulated signal carried on a plurality of subchannels, comprising:
a detector for detecting RF interference in said subchannels, identifying a said subchannel where the magnitude of said RF interference has a predetermined characteristic, determining the value of said magnitude of said RF interference with said predetermined characteristic, and determining the value of the magnitude of said RF interference in neighboring subchannels;
an estimator for estimating the value of the magnitude of said RF interference in a plurality of remaining subchannels from said determined values; and
a subtractor for subtracting the estimated values of the magnitude of said RF interference from the signals in the corresponding remaining subchannels.

11. An RF interference canceller as claimed in claim 10, wherein said predetermined characteristic is a peak magnitude.

12. An RF interference canceller as claimed in claim 11, wherein said neighboring subchannels are located on either side of said channel where the RF interference has a peak magnitude.

13. An RF interference canceller as claimed in claim 12, wherein said neighboring subchannels are immediately adjacent said channel where the RF interference has a peak magnitude.

14. An RF interference canceller as claimed in claim 11, further comprising a Fourier transform unit for performing Fourier transform on the received modulated signal.

15. An RF interference canceller claimed in claim 14, wherein said Fourier transform unit is a fast Fourier transform (FFT) unit.

16. An RF interference canceller in claimed in claim 14, wherein said estimator estimates the magnitude of the RF interference in said neighboring subchannels is estimated in accordance with the equation:
$$R ( {k}_{1} ) \frac{Δ}{Δ - ( k - {k}_{1} )}$$
where (k) represents the interference in the channel k and Δ is calculated in accordance with the equation
$$\vert Δ \vert = \frac{max ( \vert R ( {k}_{1} + 1 ) \vert , \vert R ( {k}_{1} - 1 ) \vert )}{\vert R ( {k}_{1} ) \vert + max ( \vert R ( {k}_{1} + 1 ) \vert , \vert R ( {k}_{1} - 1 ) \vert )} \qquad ( 4 )$$

17. An RF interference canceller as claimed in claim 10, wherein said detector compares a detected RF signal with a predetermined threshold.

18. An RF interference canceller as claimed in claim 10, wherein said subtractor said modulated signal is a DMT signal.
